(19) United States
(12) Patent Application Publication
(10) Pub. No.: US 2010/0250463 A1
(43) Pub. Date: Sep. 30, 2010

(54) INFORMATION-DELIVERY SYSTEM AND METHOD AND APPLICATIONS EMPLOYING SAME

(75) Inventors: Dara O'Rourke, Albany, CA (US); Kelly Bryant, San Francisco, CA (US); Graham Bullock, Berkeley, CA (US); Alastair Iles, North Balwyn Victoria (AU); Helen Kim, San Francisco, CA (US); Shufei Lei, Alemeda, CA (US)

Correspondence Address: Trellis Intellectual Property Law Group, PC, 1900 EMBARCADERO ROAD, SUITE 109, PALO ALTO, CA, 94303, US

(73) Assignee: THE REGENTS OF THE UNIVERSITY OF CALIFORNIA, Oakland, CA (US)

(21) Appl. No.: 12/794,718

(22) Filed: Jun. 4, 2010

Related U.S. Application Data
(62) Division of application No. 11/544,020, filed on Oct. 4, 2006.

(51) Int. Cl. G06Q 99/00

(52) U.S. Cl. 705/347; 235/375

(57) ABSTRACT

In one embodiment, an information-delivery system includes a first mechanism for identifying an entity for which to gather information and providing identity information in response thereto. A second mechanism employs the identity information to retrieve rating information pertaining to the entity, wherein the scoring information includes quantified information pertaining to one or more measures of performance, and the user's ethical preferences. The rating information includes environmental information, health information, and/or social information. The rating information further includes components that are each associated with a user-configurable weight. The second mechanism includes plural data sources, wherein each data source is associated with a user-configurable data-source weight. This allows a user to scan a product, receive information on its social, environmental, and health performance, all screened through the user's personal preferences.

### BACKGROUND

Embodiments of the present invention are related in general to information-delivery systems and more specifically to information-delivery systems and methods for providing information about an entity, such as a product, brand, company, investment, and so on.

When shopping for a product, a user often researches the product before purchase. Various factors may be considered. Thus, delivering product information to the user may influence the user's choice. Product information may be delivered to the consumer via advertising, product labeling, price tags, websites, and so on. Unfortunately, the product information is often limited to product features, capabilities, and price. This information is sometimes useful to a user but may not provide all the information a user desires.

### SUMMARY

Certain embodiments of the invention provide a system for selectively retrieving information. In one embodiment, the system enables users to make more informed purchasing decisions so that the decisions more closely reflect their values and preferences, including ethical preferences. The system includes a first interface that is adapted to receive identification information pertaining to an entity, such as a product, brand, or company. A second interface automatically retrieves one or more ratings pertaining to the entity based on one or more predetermined user preferences in response to input of the identification information

In one embodiment, the one or more predetermined user preferences are user-configurable via one or more weights associated therewith. The one or more ratings include ratings pertaining to environmental, health, social, and/or political information or criteria and further include one or more sub-ratings pertaining to each rating.

Hence, this embodiment provides a system for enabling users to make decisions, such as purchase decisions, that support and reflect their values. Such a system fills the gap that currently exists between what consumers want to know about the environmental, social, and health impacts of products they buy and the information readily available on those impacts. Consumers have heretofore been relatively unable to act on their values and concerns. This embodiment facilitates delivering new information services to consumers that radically increase their knowledge. This information may transform consumer relationships with retailers, producers, and other consumers, thereby facilitating a Web-based mobile community that connects buyers and sellers through new information tools and mechanisms for screening products, brands, companies, and so on.

By employing certain embodiments of the present invention, consumers may more readily buy products that better represent their values, thereby furthering values in the market place by influencing consumption and production practices accordingly. Hence, certain embodiments of the invention may contribute to society by providing an improved mechanism by which consumer values influence which products are purchased, and ultimately which products are produced.

### BRIEF DESCRIPTION OF THE DRAWINGS

FIG. 1 is a diagram of an information-delivery system according to a first embodiment of the present invention.

FIG. 2 is a flow diagram of a first method adapted for use with the system of FIG. 1.

FIG. 3 is a diagram of an information-delivery system according to a second embodiment of the present invention.

FIG. 4 is a flow diagram of a second method adapted for use with the system of FIG. 3.

FIG. 5 is a diagram of a first exemplary graph for setting criteria weights and/or displaying sub-ratings via the user-interfaces of FIGS. 1 and 3.

FIG. 6 is a diagram of a second exemplary graph for setting criteria weights and/or displaying sub-ratings via the user-interfaces of FIGS. 1 and 3.

FIG. 7 is a diagram of a third exemplary graph for setting criteria weights and/or displaying sub-ratings via the user-interfaces of FIGS. 1 and 3.

FIG. 8 is flow diagram of a third method that is adapted for use with the systems of FIGS. 1 and 3.

FIG. 9 is a diagram illustrating an intelligent marketing system according to a third embodiment of the present invention.

FIG. 10 shows a system for providing social impact factor data according to one embodiment.

### DESCRIPTION OF EXAMPLE EMBODIMENTS

For clarity, various well-known components, such as computer operating systems, communications ports, Internet Service Providers (ISPs), exchange standards, and so on have been omitted from the figures. However, those skilled in the art with access to the present teachings will know which components to implement and how to implement them to meet the needs of a given application.

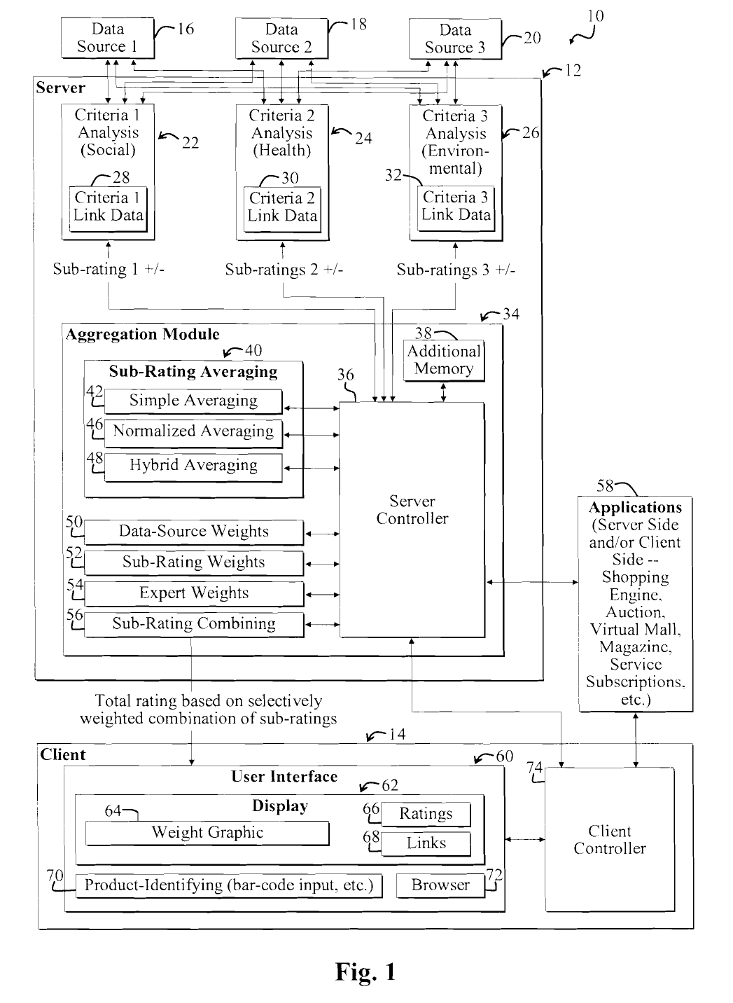

FIG. 1 is a diagram of an information-delivery system 10 according to one embodiment of the present invention. The information-delivery system 10 includes a server 12 in communication with a client 14. In the present specific embodiment, the server 12 includes a first criteria-analysis module 22, a second criteria-analysis module 24, and a third criteria-analysis module 26, all of which receive input from external data sources, including a first data source 16, a second data source 18, and a third data source 20. For illustrative purposes, the criteria-analysis modules 22-26 arc associated with criteria-link data 28-32, which a user may access for additional information pertaining to criteria employed by the criteria-analysis modules 22-26, as discussed more fully below.

The server 12 further includes an aggregation module 34, which includes a server controller 36 in communication with a sub-rating-averaging module 40, data-source weights 50, sub-rating weights 52, expert weights 54, and a sub-rating combining module 56. The sub-rating-averaging module 40 includes a simple-averaging module 42, a normalized-averaging module 46, and a hybrid-averaging module 48. The server controller 36 further communicates with additional server memory 38, the criteria-analysis modules 22-26, additional applications 56, and a client 14. Note that the additional applications 58 may be implemented via code running on the server 12, i.e. as server-side applications and/or as code running on the client 14, i.e., as client-side applications. Exemplary applications include shopping applications, electronic auctions, virtual malls, electronic magazines, and a service-subscription interface for enabling users to subscribe to services implemented via the system 10.

For the purposes of the present discussion, a client may be any device that receives information from a network, such as from a server in the network, such as in response to a query or a push from the server to the client. A server may be any computer program, which may be implemented in hardware and/or software, that can provide data and/or functions to another network entity, such as another program or module, in response to a query from the other program or module or via a push to the other program or module. An application may be any software and/or hardware code or set of instructions that implement certain functions.

The client 14 includes a client controller 74, which communicates with the server controller 36 of the server 34. The client 14 further includes a user interface 60, which includes a product-identifying system 70, a browser 72, and a display 62 that selectively displays a weight graphic 64, ratings 66, and links 68 to products and associated companies and/or to the criteria-link data 28-32. The links 68 may facilitate accessing additional information pertaining to each type of criteria employed by the criteria-analysis modules 22-26.

In operation, a user employs the client 14 to input information identifying an item, which may be anything that may have social impact factor data associated with it. For example, the item may be a product, brand, company, or other entity. Also, the item does not have to be physical but may be an idea, person, etc. For example, a user may employ the product-identifying module 70, which may be implemented via a barcode scanner, camera on a cell phone, manual entry of the UPC code, and so on. Note that the client 14 may be implemented via Personal Computer (PC) or mobile computer, such as a cell phone or Personal Digital Assistant (PDA). A computer may be any processor in communication with a memory. Hence, cell phones, Personal Digital Assistants (PDAs), bar-code scanners, and so on, are considered computers.

In the present specific embodiment, the product-identifying module 70 implements a barcode scanner. A barcode, such as a Universal Product Code (UPC) for a product is scanned via the product-identifying module 70, yielding a digital product identity. Although a barcode is referred to, any other identifiers may be used, such as images, etc. The resulting product identity is forwarded to the server controller 36 via the client controller 74, where it may be stored in the additional memory 38. The user may employ the user interface 60 to store additional information, such as preferred data-source weights, sub-rating weights, expert weights, and so on, via the additional memory 38 in the server 34.

For the purposes of the present discussion, weights may be any values that scale the importance of data or otherwise affect the contribution that certain data makes to the determination of a ranking, rating, or other score or value. Scoring information may be any data that represents or is used to calculate one or more numerical values or ranges of numerical values associated with a criterion, criteria, or information. Hence, scores, sub-ratings, total ratings, and rankings may all represent types of scoring information. Furthermore, the information or criteria used to determine the scores, sub-ratings, total ratings, and so on, may represent scoring information.

Information stored for a particular user may be organized in a user profile stored via the server 12, such as via the additional memory 38 of the aggregation module 34. However, user-profile information may be stored on the client 14 or both on the client 14 and the server 12 without departing from the scope of embodiments of the present invention.

One or more routines running on the server controller 36 employ the product identity to selectively query the data sources 16-20 for relevant information. Queries may be relayed through the criteria-analysis modules 22-26 or routed directly from the server controller 36 to the data sources 16-20. The data sources 16-18 may be implemented via various types of databases, including wiki-based systems, wherein users contribute to the data, government databases, Socially Responsible Investing (SRI) databases, and so on.

In the present specific embodiment, the data sources 16-20 provide social impact factor data to the first criteria-analysis module 22, provide health-relevant information to the second criteria-analysis module 24, and provide environmentally-relevant information to the third criteria-analysis module 26. Individual data sources 16 may also provide data to more than one criteria-analysis module 22-26. Additionally, any number of criteria-analysis modules may be used.

For the purposes of the present discussion, health-relevant information may be any health information, such as information employed to make a decision that may affect one's physical, emotional, or mental well being. For example, information pertaining to levels of certain chemicals in a particular type of fish or shampoo, and information indicating cholesterol levels are examples of health-relevant information.

Socially relevant information may be any information employed to make a decision that may affect society or societal values. For example, information pertaining to the impact of a given product or company on communities, impacts of the product or company on conditions of the workplace and workers, and so on, represent examples of socially relevant information.

Environmentally relevant information may be any information employed to make decisions that may affect the environment or environmental values. Environmental values may be any preferences towards factors that may impact the environment. For example, one may value use of solar-energy over energy derived from fossil fuels or may value products that use alternatives to ozone-depleting chlorofluorocarbons (CFCs). Such preferences or values are considered to be environmental values.

Health-relevant, socially relevant, and environmentally relevant information may overlap. For example, certain health-relevant information, such as information pertaining to the effects of certain controversial medications or chemicals, and so on may also be socially relevant. Furthermore, certain types of environmentally relevant information, such as the release of certain chemicals into communities or workplaces may be considered socially relevant in as much as the associated environmental information impacts society.

By way of example, the first criteria-analysis module 22 analyzes social information about the identified product from the three data sources 16-20 with respect to certain social criteria and produces a resulting sub-rating. For example, the information pertaining to whether production of the product involved sweatshops, adversely affected a community, was imported from a certain country with poor labor or human rights practices, was produced by a large corporation instead of a local store, and so on, may represent criteria used by the first criteria-analysis module 22 to compute a sub-rating, which may be positive or negative. A user may assign different score weights to different criterion or criteria may via the user interface 60 of the client 14. The score weights affect the computation of the sub-rating such that criteria associated with higher score weights make a larger contribution to the value of the resulting sub-rating. In the present specific embodiment, the score weights represent a subset of the sub-rating weights 52, which are also called criteria weights, as discussed more fully below.

The first criteria-analysis module 22 runs an algorithm to compute the social sub-rating based on the social information retrieved from the data sources 16-20, score weights 52, and data-source weights 50, which may be default values or may be obtained from the user via the client 14. A user may provide the initial mapping that maps product social information to scores. These mappings may be stored at the data sources 16-20. Alternatively, the mapping may be computed automatically via an artificial-intelligence algorithm or other program.

The social impact factor data retrieved from the data sources 16-20 may comprise scores for different subsets of criteria, such as subsets of social criteria. The criteria-analysis module 22 then weights these scores based on which data source provided the scores and the data-source weights associated therewith, and further based on score weights associated with each score. Alternatively, various weights, such as score weights, data-source weights, and sub-rating weights may be automatically determined. Alternatively, the weights are default weights or expert weights 54. The expert weights 54 may represent weights used by certain experts or others who have made weights in their profiles available to other users of clients implemented according to an embodiment of the present invention.

For example, to compute a social sub-rating, the first criteria-analysis module 22 may multiply scores for each sub-criteria (e.g., community influence, workplace contributions, corporate governance, etc.) from the data sources 16-20 by the product of the associated data-source weight and the corresponding score weight. The first criteria-analysis module 22 may then add the resulting weighted score with other scores from the data sources 16-20 to yield a sub-rating.

Sub-rating computations performed by the second criteria-analysis module 24 and the third criteria-analysis module 26 may be similar to the computations performed by the first criteria-analysis module with the exception that the criteria-analysis modules 24, 26 may employ different sets of criteria, namely health criteria, and environmental criteria, respectively. Examples of health criteria include cancer risks, toxicity, organic content, legality of ingredients, and so on. Examples of environmental criteria include whether the production of a product has yielded toxic waste, may contribute to climate change, and so on. When using default settings, products that are associated with cancer risks, that are toxic, or that lack organic ingredients will result in lower sub-ratings than products that are not toxic, associated with cancer, and contain organic ingredients. Similarly, products that are generally beneficial to the environment will be associated with higher sub-ratings than those that are not. A user's particular ethics or values pertaining to different sub-criteria, as reflected in data-source weights 50 and score weights 52, may affect values of the sub-ratings output by the criteria-analysis modules 22-26.

The sub ratings are forwarded to the server controller 36, which runs an algorithm for selectively combining the sub-ratings into a total rating based on sub-rating weights 52. Information provided by the various data sources 16-20 may be considered as representing different components of a total rating. Furthermore, the sub-ratings and accompanying score weights may also represent components of the total rating. A sub-rating may be any value that is used in the computation of another rating or value.

The sub-rating weights 52 may be provided via a user of the client 14 via the user interface 60 or may be borrowed from expert profiles as expert weights 54. The sub-rating weights affect the relative contributions that each sub-rating makes to the total rating for a particular product, brand, company, etc. For example, the server controller 36 may run an algorithm that multiplies each sub-rating with the corresponding sub-rating weight 52 and that then adds the resulting weighted sub-ratings to yield a total sub-rating. The total sub-rating for the scanned product and/or associated company and/or brand may then be displayed via the client display 62. The weight graphic 64 of the display may efficiently graphically depict the sub-ratings, weights, and total rating for a particular product, as discussed more fully below.

The applications 58 may employ total ratings and sub-ratings for various products, which may be calculated via default weights, expert weights, and or user-selected weights, to display selected products for sale. For the purposes of the present discussion, an application may be any software and/or hardware code or set of instructions that implement certain functions.

Exact details for methods for selecting products, companies, brands, or other entities for participation in various applications 58, such as electronic auctions, virtual malls, electronic magazines, and so on, are application specific. Those skilled in the art with access to the present teachings may readily employ social, health, environmental, or other information, which may be incorporated in ratings, to implement an application that employs the ratings without undue experimentation.

Generally, the system 10 of the present specific embodiment enables users to make more informed decisions, such as when making purchase decisions. The scores, sub-ratings, and weights used to compute the ratings may reflect a user's ethics preferences or values. For the purposes of the present discussion, ethics or ethics preferences may be any values or preferences used to determine what is right or wrong or beneficial or not beneficial to personal or societal outcomes. Consequently, use of the system 10 may result in market forces that act to promote user values. For example, companies may have additional incentives to be environmentally conscious, health conscious, socially conscious, and so on, or otherwise risk reduced sales of their products.

While in the present embodiment, only one client 14 is shown communicating with one server 12, multiple clients and/or multiple servers may be employed without departing from the scope of embodiments of the present invention. Furthermore, note that the criteria-analysis modules 22-26 may be implemented outside of the server 12, such as via databases that implement the data sources 16-20 without departing from the scope of embodiments of the present invention. In addition, while each data source 16-20 is shown communicating with each criteria-analysis module 22-26, the data sources 16-20 may communicate with more or fewer criteria-analysis modules 22-26. Furthermore, while only three data sources 16-20 are shown, more data sources may be employed. For example, plural wiki databases may be employed. For the purposes of the present discussion, a wiki database may be a database that enables users to contribute information to or edit information contained in the database.

In addition, more or fewer criteria-analysis modules 22-26 may be employed. Social, health, and environmental criteria-analysis modules are shown for illustrative purposes. Other types of criteria, other than social, health, or environmental-based criteria may be employed to selectively rate products. For example, politically relevant information may be employed to rate a product, company, brand, and so on. For the purposes of the present discussion, politically relevant information may be any information employed to make a decision that may affect government policies, political values, election candidates, and so on. Politically relevant information may be considered a subset of socially relevant information.

The various weights employed to calculate a given rating may be considered user-preference information. For the purposes of the present discussion, user-preference information may be any information that reflects a user desires, wishes, or values.

While the system 10 is primarily discussed with respect to the rating of products, embodiments of the present invention are not limited thereto. For example, investments, services, organizations, and so on, may be rated via certain embodiments of the present invention without departing from the scope thereof.

By enabling users to select data-source weights 50 and sub-rating weights 52, the system 10 allows users to not just weight criteria and data sources, but to select them. For example, if a user would like to omit a particular data source, the user may set the associated data-source weight to zero. Similarly, if a user would like to omit a certain type of information, such as health information, from a particular rating, the user may set the corresponding sub-rating weight, i.e., criteria weight to zero. Consequently, consumers can choose what issues that they care most about. For example, one consumer might weight their own personal health as a primary concern by assigning a maximum weight to health information, while another person might weight animal rights as their primary concern by assigning a maximum score-weight to animal-rights information. Users can also select sources of information that they trust most. For example, one consumer might only want data from a trusted non-governmental organization, while another user might only want data from the government.

Users can store product information locally, such as in a mobile phone memory, as discussed more fully below, or on the server 12, such as via the additional memory 38. A user can build a personal database, at a website so that product information need not be downloaded twice. Additional functionality or less functionality may be incorporated into an embodiment of the present invention without departing from the scope thereof

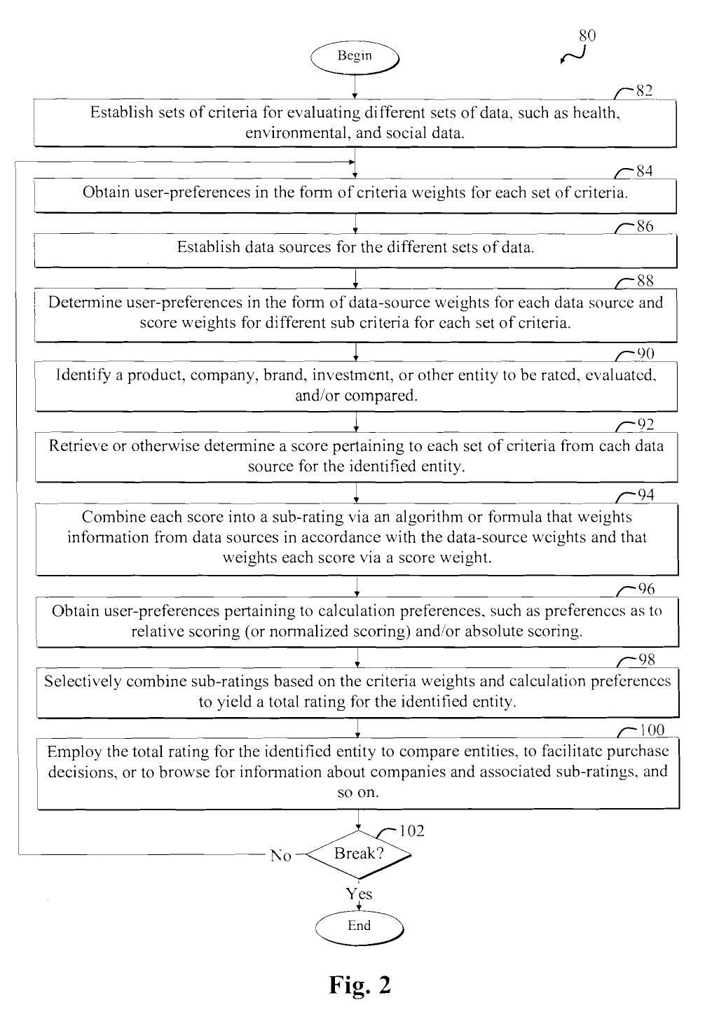

FIG. 2 is a flow diagram of a first method 80 for use with the system 10 of FIG. 1. The method 80 includes first step 82, which includes establishing sets of criteria for evaluating different sets of social impact factor data. The different sets of social impact factor data may include health, environmental, social information. The terms health information, environmental information, and social information discussed herein arc employed interchangeably with health-relevant information, environmentally relevant information, and socially relevant information, respectively.

In a second step 84, user preferences in the form of criteria weights for each set of criteria are obtained.

A third step 86 involves establishing data sources for the different sets of data. The different sets of data may represent initial scores associated with different sub-categories or categories of information, i.e., criteria.

A fourth step 88 includes determining user data-source preferences, i.e., values, which arc reflected in data-source weights fore each data source. User preferences, default preferences, or expert preferences in the form of score weights for different sub-criteria for each set of criteria arc also determined.

A fifth step 90 includes identifying a product, company, brand, investment, or other entity to be rated, evaluated, compared, purchased, included in a magazine, included in a Web store, included in an online auction, and so on. Identifying information may be automatically or manually determined via a computer, such as cell phone equipped with software constructed in accordance with an embodiment of the present invention. For example, a cell phone may be equipped with barcode scanner that may communicate with a barcode interpreter to yield product-identifying information.

A sixth step 92 includes retrieving or otherwise determining a score pertaining to each set of criteria from each data source.

A seventh step 94 includes selectively combining each score into a sub-rating via one or more algorithms or formulas that weight data sources in accordance with the data-source weights and that weight scores according to corresponding score weights. Such algorithms or formulas may be implemented via the criteria-analysis modules 22-26 of the system 10 of FIG. 1.

An eighth step 96 includes obtaining user calculation preferences, such as preferences as to whether relative scoring, also called normalized averaging, or absolute scoring, also called simple averaging, is performed when calculating sub-ratings. For example, an illustrative relative-scoring algorithm scales individual scores from different data sources based on deviations from mean scores provided by each data source. Consequently, data sources that provide consistently higher scores or lower scores for different sets of data will be scaled so that scores from these data sources do not provide inordinate contributions to resulting sub-ratings. An exemplary absolute scoring algorithm employs unadulterated scores from the various data sources to compute a sub-rating. An exemplary hybrid algorithm selectively combines the relative-scoring algorithm and the absolute-scoring algorithm to meet the needs of a given application or set of user preferences.

A ninth step 98 includes selectively combining sub-ratings computed for different sets of criteria into a total rating. Criteria weights or sub-rating weights are applied to each sub-rating, and calculation preferences are employed to produce a total rating for an identified entity, such as a product. Exact details of the algorithm for combining sub-rating weights, calculation preferences, data-source weights, and scores are application specific and may be adjusted to meet the needs of a given application without departing from the scope of the present invention.

A tenth step 100 includes employing the total rating for the identified entity to compare with other ratings; to facilitate purchase decisions; to browse for information about companies; to browse information pertaining to sub-ratings, and so on.

An eleventh step 102 involves determining if a system break has occurred. A system break may occur when the system is turned off or otherwise disabled or deactivated. If a system break occurs, the method 80 ends, otherwise, the method 80 continues at the second step 84. It may also continue at step 90 if the state of the system is saved

Various steps 82-102 of the method 80 may be interchanged with other steps, omitted, combined with other steps, or modified without departing from the scope of the present invention. For example, the ninth step 98 and the eighth step 96 may be interchanged; the fourth step 88 may be omitted, and default weights employed instead, and so on.

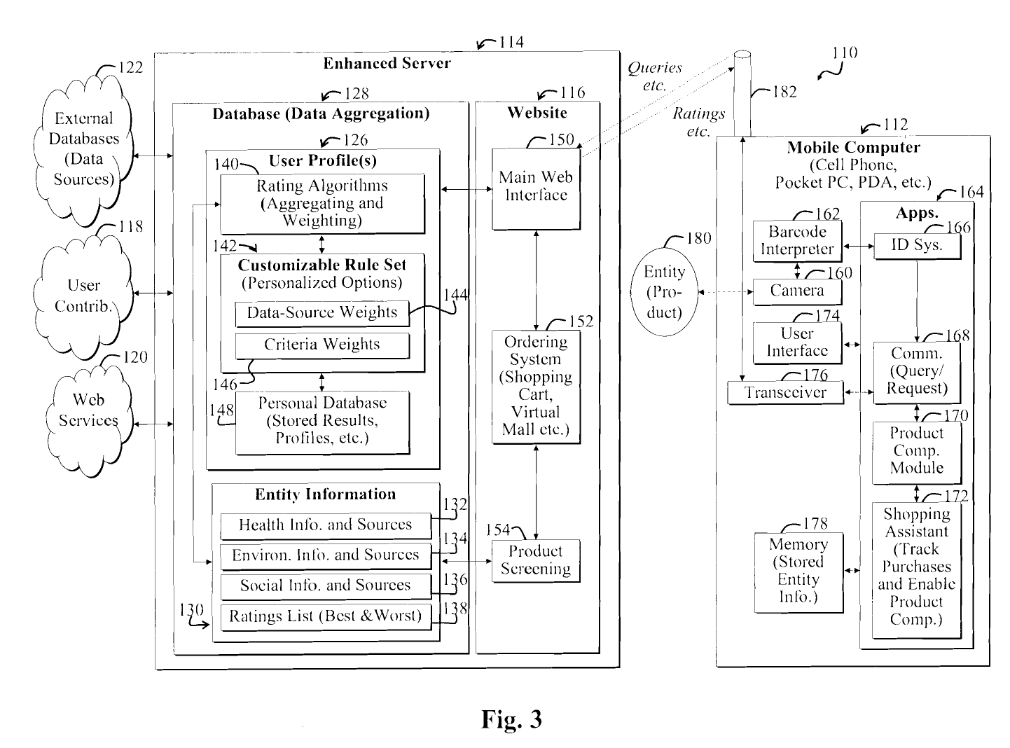

FIG. 3 is a diagram of an information-delivery system 110 according to a second embodiment of the present invention. The system 110 is similar to the system 10 of FIG. 1 with the exception that the system 110 is implemented via a different architecture that includes a mobile computer 112 as the client, an enhanced server 114, which hosts a special website 116. The mobile computer 112 may be implemented via a cell phone, a laptop, a Pocket PC, a Wi-Fi phone, or other mobile computer.

The enhanced server 114 is also adapted to receive input, such as product scores for different categories, from individual user contributors 118. Furthermore, various Web services 120 are shown accessing sub-ratings or ratings from the enhanced server 114 to facilitate providing various services and implementing various applications. Proprietors of the Web services 120 may license rating information from proprietors of the system 110. The enhanced server 114 further communicates with external databases 122, which are analogous to the data sources 16-20 of the system 10 of FIG. 1. In addition, the enhanced server 114 is adapted to maintain user profiles 126, such as for the user of the mobile computer 112. Note that the user profiles 126 may be maintained in the mobile computer 112 instead of in the enhanced server 114 without departing from the scope of embodiments of the present invention.

The user profiles 126 are included in an aggregation database 128, which further includes entity information 130. The entity information 130 may be retrieved via the external databases 122, the user contributors 118, and so on. The entity information 130 includes health information 132, environmental information 134, social information 136, and a ratings list 138. The ratings list 138 lists various entities, such as products, along with their associated ratings. The entity information 130 is accessible to various modules associated with the user profiles 126.

In the present specific embodiment, the user profiles 126 include rating algorithms 140, customizable rule sets 142, and personal databases 148. The customizable rule sets include data-source weights 144 and criteria weights 146. The user profiles 126 are accessible to the mobile computer 112 via the website 116. The website 116 includes a main Web interface 150, an ordering system 152, and a product-screening module 154.

The mobile computer 112 includes an on-board camera 160 (or detachable, stand-alone, etc.), which is employed to photograph the entity 180. The camera 160 communicates with a barcode interpreter 162, which communicates with client-side applications 164. The client-side applications 164 include an identification system 166, which provides input to a communications module 168. The query/request generator 168 communicates with a product-comparison module 170, which further communicates with a shopping assistant 172. The shopping assistant 172 may facilitate storing purchase information, such as pertaining to the entity 180, in a memory 178. The communications module 168 further communicates with a transceiver 176, which employs an antenna 182 to wirelessly connect to the Internet (not shown) to access the website 116. The mobile computer 112 further includes a user-interface 174, such as a keypad, display, microphone, user-interface application, and so on, which may work with the client-side applications 164.

In operation, a user employs the user interface 174 and communications module 168 to connect with the website 116. The main Web interface 150 of the website 116 may be displayed on the user interface 174 of the mobile computer 112, enabling user access to the ordering system 152 and allowing the user to set up a user profile 126 or otherwise access another user profile that has been stored in the personal database 148. Upon logging in to the website 116, the user may customize the user profile 126 or use a default user profile. In the default profile, data-source weights 144 and criteria weights 146 exhibit default values. Alternatively, the user may customize the data-source weights 144 to adjust the contribution that any given data source 118, 122 makes to product ratings or ratings of other entities. The user may further customize the criteria weights 146 to influence the contribution that each type of entity information 132-138 makes to a given product or other entity rating. The Wcb interface 150, the user interface 174, and communications module 168 also include instructions that enable a user to store ratings for scanned products, to store profiles, and so on. Exact details, such as software code, for implementing particular databases, log-in features, profile-creation steps, enabling setting of criteria weights, and so on, are application specific and may be readily developed by those skilled in the art without undue experimentation.

In a first illustrative operating scenario, the user employs the camera 160 to photograph a barcode affixed to the entity 180, which is a product. The barcode interpreter 162 converts the resulting barcode image information into an electronic product identity, i.e. digital code. The product identity is then forwarded to the identification system 166, which may convert the code into a desired format for use by the communication module 168. Alternatively, the identification system 166 is omitted or incorporated into the barcode interpreter 162. The communication module 168 may then handle the code in accordance with user-instructions provided by the user and software that implements the user interface 174. For example, if the user has selected, via the user interface 174, to rate the scanned product 180, the communication module 168 then automatically accesses the website 116 and logs-in the user. The query is routed though the main Web interface 150 to the user profile 126. The rating algorithms 140 then employ the product identity to selectively retrieve corresponding entity information 130, which may be retrieved from the data sources 118, 122 if it is not already stored in the aggregation database 128. The rating algorithms then apply the data-source weights 144 and the criteria weights 146 to selectively weight the entity information 130 to yield a total rating. Additional score weights may be employed to enable a user to weight sub-components of the various types of information 132-138. The total rating is then provided to the main Web interface 150, which is accessible via the user interface 174 of the mobile computer 112.

Subsequently, in the present operative scenario, the user may wish to scan another entity or to compare the total rating of the scanned entity 180 with another product. In this case, the user employs the user interface 174 to activate the product compare module 170 and shopping assistant 172 to access previously stored product information. The product compare module 170 may retrieve previous ratings from the personal database 148 of the user profile 126 or may retrieve locally stored entity information. The product compare module 170 may then facilitate displaying a graphical overlay that compares the desired products, as discussed more fully below.

Subsequently, the user may wish to shop online via the website 116. In this case, the user employs the user interface 174 to activate the shopping assistant 172, which may then activate the ordering system 152 of the website 116. Alternatively, the user employs browser functionality implemented in the user interface 174 to manually browse to an online mall, auction, or other shopping mechanism implemented via the ordering system 152 of the website 116. While browsing, the user may activate the shopping assistant 172 to facilitate product comparisons. Results of product comparisons may be stored locally in the local memory 178 or via the personal database 148 of the aggregation database 128.

The shopping assistant 172 may include code, such as hardware and/or software instructions, to allow users to track their purchases, keep wish lists, track tagged products, evaluate the impacts of specific products, and to track the impacts of a user's overall consumption. This tool may generate, for example, “green check-out” forms that tell consumers about their environmental and social impacts at the point of sale. Such features may be particularly attractive to ethical supermarkets and stores that would like to show their shoppers the impacts of their decisions, thereby enabling the supermarkets and stores to differentiate themselves in the marketplace.

The ordering system 152 implemented via the website 116 may selectively offer only products or brands for sale that meet certain rating requirements. The product-screening module 154 may include instructions for accessing the entity information 130 to screen products for use by the ordering system 152. The main Web interface 150 may also enable access to various Web services 120, which may be offered by third parties.

In another example operating scenario, a consumer in a retail outlet, such as a drug store, scans a barcode for a bottle of shampoo. Their phone (client 112) then calls up the Web server 110 and downloads simplified rating information and detailed product information on the shampoo. The user may then scan another shampoo to compare the ratings and other available information for the first shampoo and the second shampoo. The user could then access the ratings list 138 to display a list of shampoos that rate most highly for environmental, social, or health impacts. The user could then store a particular shampoo's rating in their cell phone 112 via the memory 178; build a list of favorite products; email or Short Message Service (SMS) a friend with information on one or more products; or email or SMS the manufacturer of the shampoo to inquire about the shampoo's impacts. The user may also access pricing information pertaining to the product. Instead of using the camera 160 to scan a barcode, a user may type in or otherwise enter the UPC code or other identifying information in the mobile computer 112 via the user interface 174.

The system 110 represents an example embodiment. Various modules may be omitted or may interact in different ways without departing from the scope of the present invention. For example, the mobile computer 110 may be replaced with a desktop personal computer with the ability to access the website 116.

Various algorithms for aggregating social impact factor data on the social, environmental, and health performance of products, brands, and companies may be employed to implement embodiments of the present invention. For example, a simple averaging algorithm, also called the absolute-ratings algorithm, represents a default algorithm in the present specific embodiment. The simple averaging algorithm aggregates scores from a wide range of datasets from government, industry, non-profit organizations, universities (including our own research program), individual experts, and consumers. These numerical scores are employed to evaluate companies, brands, and products and may be based on both publicly available and proprietary information, personal interviews, scientific studies, product certifications, media reports, and other information sources. The simple averaging algorithm first classifies these scores into categories according to their content and focus, and then converts the scores into a standard five-point numerical scale (1 indicating poor performance and 5 indicating excellent performance) by dividing product or company scores by the highest score possible in the original scale.

The scores are also classified as either positive or negative in each category (e.g. positive environmental attributes or negative environmental impacts of a product), and then summed and divided by the total number of scores included in each positive and negative category. Thus, if there are three umbrella categories covering social, environmental and health categories, there will be six scores (one for positive contributions and one for negative impacts in each category). The negative-impact scores are then subtracted from the positive-contribution scores and converted back into a 0-5 point scale to calculate a sub-rating for each umbrella category. Finally, these sub-ratings are summed to create a total rating, i.e., overall performance score, for each product, brand, or company for which data is available. These total ratings arc called absolute ratings in the sense they are relative to the scale and not necessarily to the competitor scores. Scores will be available not only for companies and brands, but for individual products as well.

A normalized averaging algorithm, also called a relative-ratings algorithm, may also be employed to compute sub-ratings and total ratings for products, brands, companies, and so on. The normalized averaging algorithm normalizes scores in order to control for discrepancies among datasets from different information providers. For example, a dataset A may consistently rate companies lower than a dataset B. Consequently, a score of 3 in dataset A may be equivalent to a 4 in dataset B, relative to their other ratings. In order to take this effect into account, a normalized set of scores represents scores based on the differences from the means of particular datasets. These differences are then converted to a five point numerical scale. A similar algorithm may also be used to control for dataset biases between industries and product categories, and to calculate best-in-class or best-in-industry scores. Such an algorithm will be helpful for users wanting to invest, for example, in the best companies across a wide range of industries. For example, all datasets may consistently rate industry-A companies lower than industry-B companies, and so the highest performers will be over-represented by industry A. By calculating ratings based on the difference between a company's rating and its industry's average, the highest ratings will include the top performers across all industries in the available datasets.

A combined averaging algorithm, also called a hybrid-ratings algorithm, may alternatively be employed to compute sub-ratings and total ratings. This algorithm accounts for both relative and absolute performance of products and companies by selectively combining sub-ratings and/or total ratings produced by the simple averaging algorithm and the normalized averaging algorithm into a hybrid sub-rating and/or total rating that recognizes both best-in-class products and/or companies and best overall performers. Thus a company and/or associated product leading in a poorly performing industry may have a similar sub-rating or total rating as a company and/or associated product scoring only moderately well in a well-performing industry.

An additional set of algorithms enables advanced users to personalize and weight their ratings according to their own preferences. These algorithms focus on three elements:

Data Source Weighting: By default, the above algorithms all treat each data source equally. A government dataset has the same weight as a non-profit or consumer dataset. This has been chosen as the default because it is the most democratic option. However, some datasets may be perceived as being more reliable or trustworthy than others, and users may want their ratings to be based more heavily on those sources. An additional algorithm enables advanced users to weight the data sources based on their own preferences. Thus users can use their own knowledge about the credibility of each dataset to override the default weightings described above.

Criteria Weighting: Users will also be able to weight the importance of particular criteria that make up each category's sub-ratings and the final total ratings using a dynamic and easy-to-use interface, as discussed more fully below. Thus if some users, for example, think that impacts on their personal health arc more important than global environmental issues, or more specifically that toxic waste emissions in their community are more important than sweatshop conditions in factories in other countries, their associated weights can reflect those preferences.

Expert or Peer Opinion Rating: Users may instead want to defer to the preferences of “experts” (such as activists, scholars, other consumers, or friends and families) rather than their own preferences. An alternative algorithm enables users to use the data-source or criteria weightings of these other people, if they are willing to share them. Users would therefore be able to see if one or more of these people would accept or reject a particular product. The algorithm supports the inclusion of such data about other peoples' preferences into a user's personalized product ratings.

Certain embodiments of the present invention may also employ criteria-linked text algorithms that connect specific category scores, company and product identities, and qualitative reports about their performance in order to generate multi-layered text descriptions about each product or company's performance. Hence, health sub-scores may be linked to text describing the specific health hazards associated with particular products. This text may be in bullet-form, short summaries, and more detailed descriptions that may enable users to drill down to the level of information they are searching for. The amount and content of the text accessed by the algorithm may be customizable to the user's interests and preferences, and may come from data sources selected by the user.

In summary, the present specific embodiment employs algorithms that may incorporate multiple data sources into aggregated product, brand, and company performance ratings across a range of criteria; may incorporate user preferences regarding the importance of the criteria and the credibility of the data sources used in calculating these ratings; and may normalize these ratings and/or accompanying sub-ratings and scores to take into account the relative performance of products, brands, and companies within a particular dataset or industry.

Proprietors of systems implemented according to an embodiment of the present invention may license information, such as ratings, and may sell certifications. Such certifications could certify that products meet certain ratings criteria.

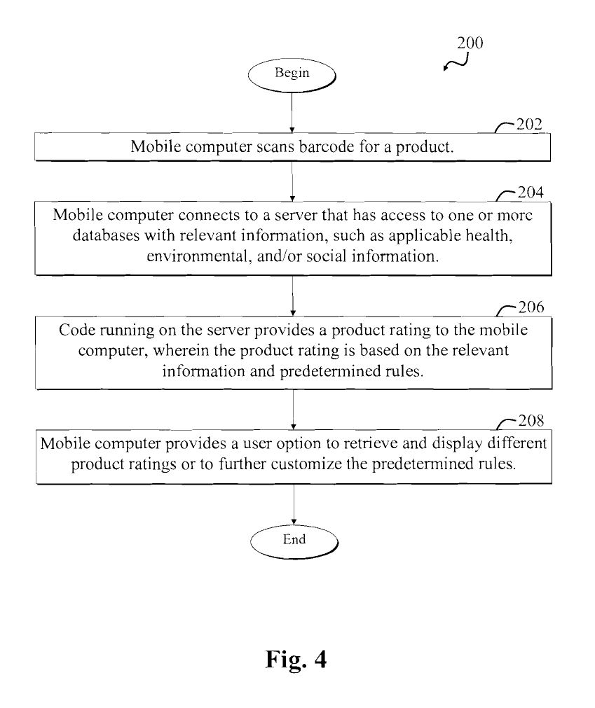

FIG. 4 is a flow diagram of a second method 200 for use with the system of FIG. 3. The method 200 includes an initial scanning step 202, wherein a mobile computer, such as a cell phone, PDA, or mobile computer 110 of FIG. 3, scans a barcode for a product.

In a subsequent connecting step 204, the mobile computer connects to a server, such as the enhanced server 114. The server has access to one or more databases with relevant information, such as applicable health, environmental, and/or social information.

Next, a rating step 206 includes activating code running on the server. The code provides a product rating to the mobile computer. The product rating is based on the relevant information and predetermined rules.

Subsequently, an option-providing step 208 provides a user option, via the mobile computer, to retrieve and display the product rating associated with the scanned barcode; to retrieve different product ratings: to display different product ratings; and/or to further customize the predetermined rules. Customization of the predetermined rules may involve selecting data-source weights, criteria weights, and algorithms that selectively combine the relevant information with the data-source weights and criteria weights to yield a particular product rating. The algorithms may include absolute ratings, normalized ratings, and other types of ratings. Exact details of selected algorithms are application specific and may vary without departing from the scope of embodiments of the present invention.

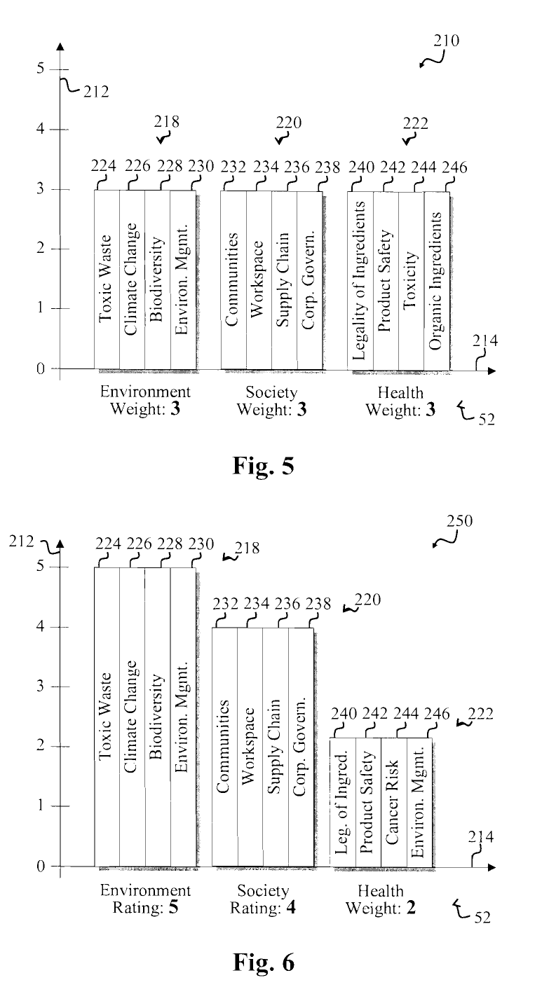

FIG. 5 is a diagram of a first exemplary graph 210 for setting criteria weights 52 and/or displaying sub-ratings via the user-interfaces 60, 150, 174 of FIGS. 1 and 3. The first graph 210 includes a vertical axis 212 depicting weights or sub-ratings and a horizontal axis 214 depicting different types of information or criteria 218-222. Each type of information 218-222 is associated with subtypes, i.e., sub-criteria. For example, in the present specific embodiment, the first type of information 218, which represents environmental information, includes a toxic-waste subtype 224, a climate-change subtype 226, a biodiversity subtype 228, and an environmental-management subtype. Similarly, the second type of information 220, which represents societal information, includes a communities subtype 232, a workspace subtype 234, a supply-chain subtype 236, and a corporate-governance subtype 238. Similarly, the third type of information, which represents health information, includes a legality-of-ingredients subtype 240, a climate-change subtype 242, a biodiversity subtype 244, and an organic-ingredients subtype 246.

The user may click and drag or otherwise adjust the heights of the various types of information 218-222, thereby setting the criteria weights for the different types of information. The first graph 210 shows that weights for the various types of information 218-222 are set to 3, which is the default weight in the present specific embodiment.

With reference to FIGS. 1, 3, and 5, each subtype 224-246 may be associated with a score that is provided by each of the data sources 16-20 of FIG. 1. Each type 218-222 may be associated with a sub-rating provided by the criteria-analysis modules 22-26. Furthermore, each type 218-222 is associated with a sub-rating weight, also called a criteria weight. Each subtype 224-246 is associated with a score weight, which may be included as a subset of the sub-rating weights 52 of FIG. 1 or the criteria weights 146 of FIG. 3. Hence, the first graph 210 shows that the all of the sub-rating weights 52, 146 and score weights are set to the default, i.e., 3.

Note that a similar graph may be used to display resulting scores and sub-ratings for the various types 218-222 and subtypes 224-246. A graph depicting scores and sub-ratings for a particular product may be overlaid on a graph depicting the corresponding weights, thereby providing a novel Graphical User Interface (GUI), which may be displayed via the interfaces 60, 150, 174 of FIGS. 1 and 3.

FIG. 6 is a diagram of a second example graph 250 for setting, criteria weights 52 and/or displaying sub-ratings via the user-interfaces 60, 174 of FIGS. 1 and 3. The second graph 250 of FIG. 6 is similar to the first graph 210 of FIG. 5 with the exception that the criteria weight for environmental information or criteria is set to 5; the criteria weight for the societal information or criteria is set to 4, and the criteria weight for health information or criteria is set to 2. Hence, in this configuration, the user has allotted maximum priority, i.e., preference, to environmental factors and has allotted a lower priority to health factors. Consequently, resulting total ratings for a given product will be more influenced by environmental information that by health information.

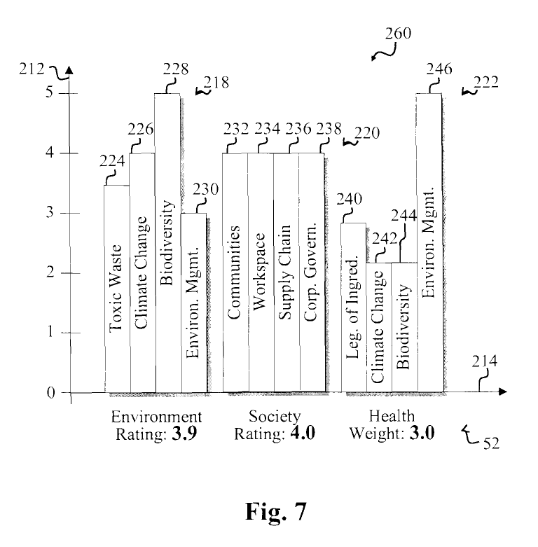

FIG. 7 is a diagram of a third example graph 260 for setting criteria weights 52 and/or displaying sub-ratings via the user-interfaces 60, 150, 174 of FIGS. 1 and 3. The third graph 260 is similar to the graphs 210, 250 of FIGS. 5 and 6 with the exception that the user has adjusted score-weights as desired. The resulting criteria weights 52 arc obtained by averaging the score weights. Variations in the score weights affect the relative contributions that the subtypes 224-246 make to the computation of a given sub-rating. This is similar to the fact that variations in the criteria-weights affect the relative contributions that the types 218-222 make to a given total rating.

The graphs 210, 250, 260 of FIGS. 5-7 represent a dynamic and innovative tool to enable users to easily set both their criteria and data source preferences. These preferences may be used to calculate ratings based on each user's personal weightings using the algorithms discussed herein.

In summary, preferences are set using a dynamic vertical bar graph, with each bar representing a specific social, environmental or health criteria. The bar graph scale is set at 0-5, with five indicating very important and zero indicating not important. Initially, each criterion in the bar graph is set at 3 as a default weighting. The criterion is grouped in the umbrella categories of environment, health, and social impacts. Color-coding may be employed as appropriate. Users may drag, such as via a computer mouse, each umbrella category up or down according to their personal preferences. They may also drag individual criterion within each category up or down as well in a manner similar to a graphics or sound “equalizer” interface commonly used on personal computers.

Each user may have a different set of preferences or “equalizer” settings emphasizing some criterion or criteria over others. A colorful set of different shaped polygons may be associated with each user, and serve as his/her ethical preferences profile and stamp of approval. Companies, brands, and products may have similar profiles based on their sub-ratings across each criterion. Since sub-ratings and total ratings are also on a 1-5 scale, ratings profiles may be overlaid with user profiles. Using graphics to animate this profile overlay, a website equipped with software for implementing the present embodiment may enable users to quickly discern where a product both exceeds and falls short of his/her own ethical preferences. This graphical overlay may be accompanied by a numerical comparison of criteria and preferences and overall scores. Products and companies can also be compared graphically using this overlay mechanism, allowing for quick and easy comparisons across a range of criteria.

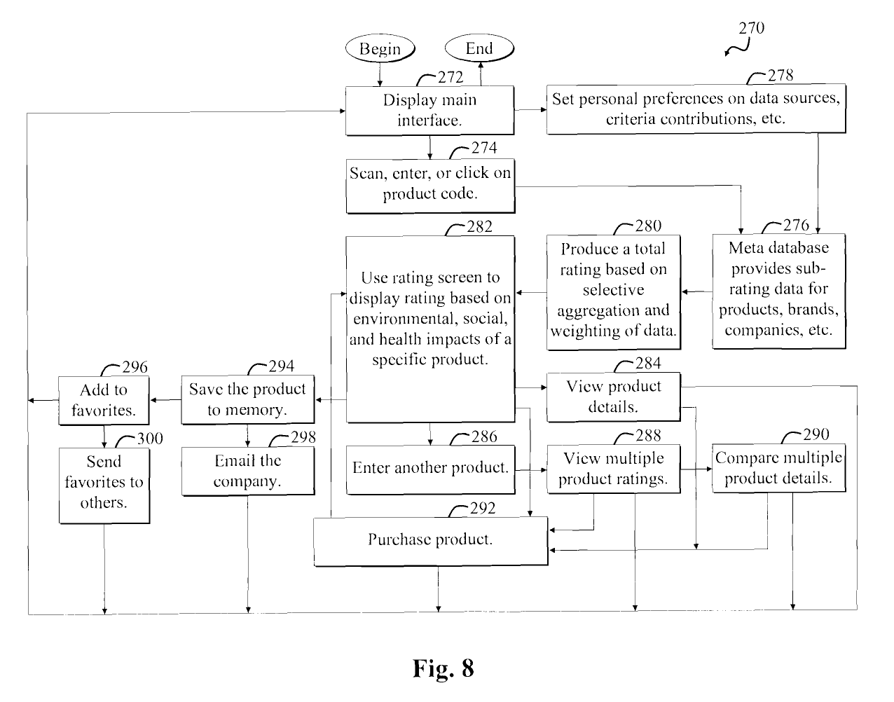

FIG. 8 is flow diagram of a third method 270 that is adapted for use with the systems 10, 110 of FIGS. 1 and 3. The third method 270 includes an initial displaying step 272, wherein a main interface, such as the user interface 174 of the mobile computer 112 of FIG. 3, provides various user options.

From the user interface, the user may enter or select a product code or trigger scanning of a product code in an entering step 274. The resulting product identity is forwarded to a meta database, such as the aggregation database 128 of FIG. 3, in a subsequent database step 276.

From the initial user-interface display, the user may also set personal preferences on data sources, the contributions of different criteria to a total rating, and so on, in a preference-setting step 278. The preference information is forwarded to the meta database for use in the database step 276.

The meta database 276 may then provide various sub-ratings for the product that was entered in the entering step 274. In the present specific embodiment, the database step 276 provides three product sub-ratings, one for each type of criteria, which includes environmental, health, and social criteria. For the purposes of the present discussion, criteria may be any information used to produce a score or a rating.

Subsequently, the database step 276 provides sub-ratings to an aggregating step 280. The aggregating step 280 produces a total rating based on predetermined algorithm or formula that combines the sub-ratings based on personal preferences set in the preference-setting step 278 or based on default preferences.

The resulting total rating is provided to a rating-displaying step 282, wherein a rating screen depicts the total rating and/or sub-ratings based on the environmental, social, and health information associated with the product.

From the interface associated with the rating-displaying step 282, the user may choose to view additional product details in a detail-viewing step 284; to scan or otherwise identify another product in a second entering step 286; to save product information, such as the rating information, to memory in a saving step 294; and to initiate purchasing of the product in a purchasing step 292.

If the user chooses to activate the detail-viewing step 284 to view additional product details, the user is provided the option to return to the initial displaying step 272 or to purchase the product in the purchasing step 292. From the interface associated with the purchasing step 292, the user may return to the interface associated with the rating-displaying step 282 or may return to the screen associated with the initial displaying step 272. Generally, the user returns to steps 272 or 282 after making an electronic product purchase, such as via the ordering system 152 of FIG. 3, or after declining a purchase.

If the user chooses to enter another product from the screen associated with the rating-displaying step 282, then step 286 is performed. The second entering step 286 may be implemented similarly to the first entering step 274. However, in the present specific embodiment, the second entering step 286 implements a screen that provides additional user options. The additional user options include viewing multiple product ratings 288 in a multiple-rating step 288 and subsequently comparing the rating details and/or other details associated with the different products in a comparing step 290.

From screens associated with the multiple-rating step 288 and the comparing step 290, a user may return to the initial displaying step 272 or may proceed to purchase one or more products in the purchasing step 292.

A user may employ the screen associated with the saving step 294 to activate an emailing step 298, which provides functionality for emailing the company associated with the entered product. Additional options include adding the product to a favorites list in an adding step 296 and sending information about the product to others in a sending step 300. From the various steps 288-300, a user may activate the initial displaying step 272 and associated interface screen. The option to access the initial interface screen associated with the initial displaying step 272 may be included in any of the steps 274-300.

The various connections between the steps 270-300 and associated user-interface screens may be changed or augmented without departing from the scope of the present invention. For example, the saving step 294 may provide an option to return to the purchasing step 292, the rating-displaying step 282, and so on. Similarly, any step 272-290 may provide an option to jump to any other step 272-290 without departing from the scope of the present invention. Connections between steps are application specific. Furthermore, various steps may be omitted and/or additional steps may be added without departing from the scope of the present invention. For example, steps that enable a user to enter an auction, an electronic magazine, or activate other functionality may be included.

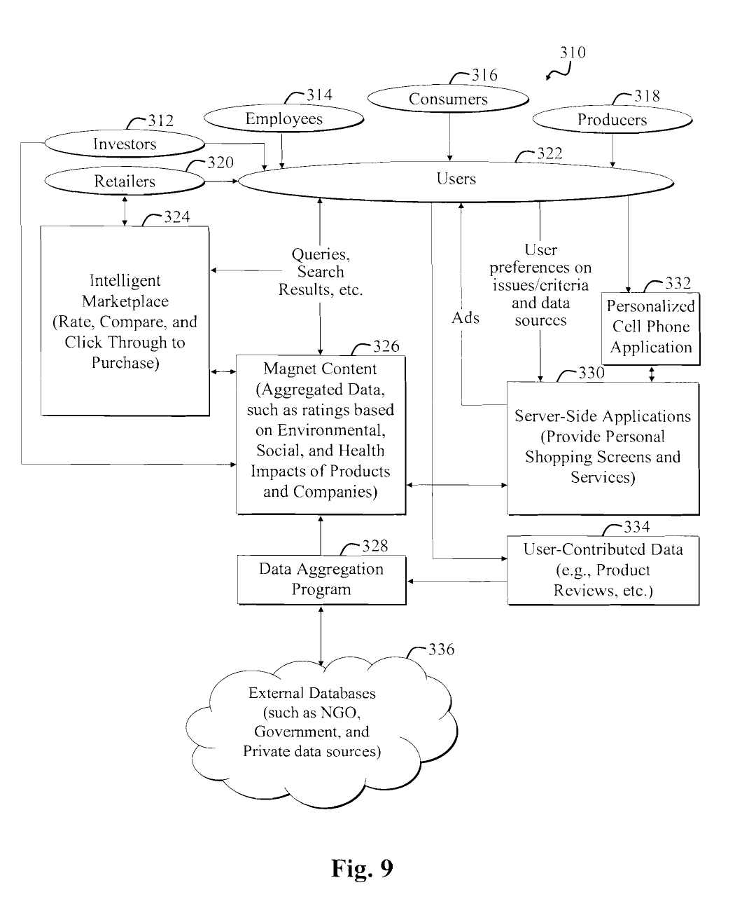

FIG. 9 is a diagram illustrating an intelligent marketing system 310 according to a third embodiment of the present invention. The marketing system 310 includes plural users 322, including investors 312, employees 314, consumers 316, producers 318, and retailers 320. The users 322 may query and search aggregated content 326 for desired information about products, brands, companies, and so on. The aggregated content 326 may contain various ratings and sub-ratings based on environmental, social, health, and political impacts of various products, brands, companies, and so on.

An intelligent market place 324, which may be implemented via an online website, may include instructions for rating, comparing, and purchasing products. The intelligent market place 324, which is accessible to the users 322, may selectively access the aggregated content 326 to screen products, display ratings, and soon. The retailers 320 may have special access to the intelligent market place 324 to post products for sale, remove products, register with the marketplace, and so on.

Investors 312 may have special access to the aggregated content 326. For example, certain investors may purchase or license information maintained via the aggregated content 326. The aggregated content 326 may be populated by a data aggregation program 328, which may receive user-contributed data 334, such as product reviews, and so on. The data-aggregation program 328 may also employ an information exchange standard to access external databases 336, such as Non-Governmental Organizations (NGOs), government databases, socially responsible investment databases, and other private sources of data.

Various server-side applications 330 may also access the aggregated content 326. The server-side applications 330, which may provide personal shopping screens, Web services, job matching assistance, and so on, may be accessible via personalized client applications 332, such as cell-phone applications. The server-side applications 330 may also forward advertisements to the users 322 and may receive user-preference information, such as criteria weights and data-source weights that reflect user values, such as ethics. This preference information may be employed by certain server-side applications that compute ratings and sub-ratings based on the aggregated content 326, which may include scores for various sub-criteria associated with a given type of information, such as environmental or social information.

For the purposes of the present discussion, a server-side application may be any application, such as a software and/or hardware program, running on a server. Similarly, a client-side application may be any application running on a client.

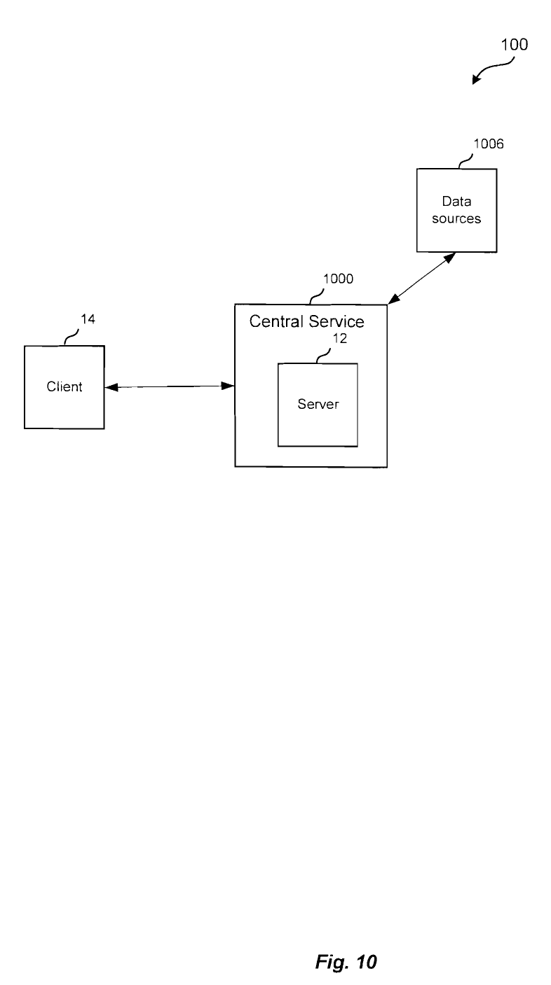

FIG. 10 shows a system 1000 for providing social impact factor data according to one embodiment. As shown, a central service 1002, client 14, and data sources 1006 are provided.

Central service 1002 includes a server 12 that receives data from data services 1006. This data may include social impact factor data such as data relating to safety, health, the environment, politics, etc. In general, social impact factors can be characterized as relating to or affecting a purpose or interest of a purchaser/user.

Social impact factors can include data that is derived from other, original, data. The derived data can be obtained by a comparison, correlation, mathematical relation, logical, statistical or other processing of two or more databases.

For example, in a case where a user dentifies a product, a first database can be used to examine all ownership entities of the product. For example, if the product brand name is owned by a first company and the first company is owned by a second company, and the second company also owns a third company, both the first, second and third companies might be considered as beneficiaries of a sale of the product. A second database can then be consulted to determine where the first, second and third companies have processing facilities that fall under environmental regulations of respective regionalities. A third database can be used to find out if any of the facilities have been in violation of pollution regulations. The correlated result of the three databases can be used to indicate a level or ranking of the identified product. Any number of databases can be correlated to achieve social impact factors of this second type.

Social impact factors can be further processed to help provide a ranking or recommendation to a user about an identified product. A user's likes or dislikes can be used to filter, weight or otherwise modify data used in a ranking or recommendation. For example, if a user indicates that they care strongly about human rights but not so strongly about the ecology then a recommendation can be used that relies more upon data factors and correlated factors relating to human rights (e.g., whether the product beneficiaries are in countries with strong human rights laws) and relies less upon factors relating to ecological considerations (e.g., whether disposal of a product results in health hazards).

Particular embodiments deliver social impact factor data to a user on demand. For example, a user may use client 14 to access social impact factor data for a product. The social impact factor data may be data that has been aggregated by server 12. The social impact factor data allows a user to make informed decisions about a product, service, etc. In one embodiment, the social impact factor data may be data that has not been generated by a company that owns or is profiting from a sale of the product. For example, the social impact factor data may be generated by a neutral company that does not have an interest in profiting from the sale. This provides objective and useful data to a user.

Because the social impact factor data is not generated by the company profiting from the product, the data used to generate the social impact factor data may be in various forms. Server 12 is configured to determine data from data sources 1006, analyze it, and generate social impact factor data from it. This may involve analyzing the data to determine if it is associated with the company. For example, the data may not explicitly state that it is associated with a company. In one example, the data may be manufacturing data from a manufacturing plant. The data may not indicate that the plant is manufacturing products for a specific company. However, using correlating information, server 12 may determine that the manufacturing data is associated with the company. This data is then used in generating social impact factor data for the company/product.

The social impact factor data delivered to a user may be based on user preferences. For example, a user's preferences may be used to determine which impact factors are most important to that user. In one example, the health impact of a product may be most important.

The user preferences of a number of users may be used to create a community that shows aggregated preferences. For example, a number of users may indicate that they are most interested in the global warming affects of a product. These community concerns may then be used to influence the company. For example, if a large percentage of users indicate that they are concerned with global warming, the company may be influenced to change its practices so it can receive a better social impact factor score for global warming.

Although a process or module or device of the present invention may be presented as a single entity, such as software executing on a single machine, such software and/or modules can readily be executed on multiple machines. Furthermore, multiple different modules and/or programs of embodiments of the present invention may be implemented on one or more machines without departing from the scope thereof.

Any suitable programming language can be used to implement the routines or other instructions employed by various network entities. Exemplary programming languages include C, C++, Java, WAP/XHTML, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed simultaneously.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “machine-readable medium” or “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a”, “an”, and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1-8. (canceled)

9. An information-delivery device comprising:
an identifier configured to identity information from an item; and
a requester configured to send the identity information to a service, the service configured to determine social impact factor data for the item; and
a receiver configured to receive the social impact factor data for the item and provide the social impact factor data to a user

10. The device of claim 9, wherein the identifier comprises a barcode scanner, a camera, and/or a mobile computer.

11. The device of claim 9, wherein the social impact factor data comprises environmental, health, and/or social data.

12. The device of claim 9, wherein the social impact factor data is computed using user preferences specified by the user.

13-19. (canceled)

20. A method for providing social impact factor data to a user, the method comprising:
receiving an identifier for an item from a user device, the identifier determined at a point of offer;
determining an entity associated with the item;
determining social impact factor data associated with the entity and/or product;
determining user preferences for a user associated with the user device;
using the user preferences to determine user-specific social impact factor data for the user; and
sending the user-specific social impact factor data to the user device such that the social impact factor data is received at the user device for use at the point of offer.

21. The method of claim 20, further comprising:
receiving data from data sources; and
analyzing the data to determine an entity associated with the data.

22. The method of claim 21, further comprising associating the data associated with the entity with the item for the entity.

23. The method of claim 20, further comprising:
aggregating user preferences for a plurality of users; and
determining social impact factor influences based on the user preferences, the social impact factor influences indicating a community preference for the plurality of users.

24. The method of claim 20, wherein the identity comprises a bar code, wherein the entity is determined from the bar code.

25. The method of claim 20, wherein the user device is a mobile device, wherein the social impact factor data is available on the mobile device at the point of offer.

26. The method of claim 20, wherein the social impact factor data is determined from a second entity different from the entity.
